(19) United States
(12) Patent Application Publication
(10) Pub. No.: US 2005/0157300 A1
(43) Pub. Date: Jul. 21, 2005

(54) Biochip scanner device

(76) Inventors: Jiann-Hua Wang, Taipei (TW); Hui Ju Chen, Dongshan Township (TW); Tzu-Chiang Wu, Miaoli City (TW); Chien-Ho Chuang, Kaohsiung (TW); Tsung-Kai Chuang, Tainan City (TW)

Correspondence Address: BIRCH STEWART KOLASCH & BIRCH, PO BOX 747, FALLS CHURCH, VA, 22040-0747, US

(21) Appl. No.: 10/760,465

(22) Filed: Jan. 21, 2004

(51) Int. Cl. G01N 21/64

(52) U.S. Cl. 356/417

(57) ABSTRACT

A biochip scanner device includes a light source for emitting a light beam; a light processing unit for focusing the light beam onto the biochip to excite fluorescence from a fluorescent target on the biochip; a filter for filtering off the light beam from the light source; a photomultiplier tube (PMT) for detecting and converting the fluorescence into an electrical signal; and an output device for outputting/displaying the electrical signal detected by the PMT. No conversion of the output signal of the output device into image data is needed. A real-time analysis proceeds while samples are being scanned on the biochip. The biochip scanner device of the present invention reads the electrical signal from PMT directly without processing it into image data and setting lens before the PMT is no longer needed. As a result, the structure of the device is simplified and the cost for production is reduced.

### BACKGROUND OF THE INVENTION

1. Field of the Invention

The present invention relates to a biochip scanner device, particularly to a biochip scanner device to detect fluorescent signal emitting from biochips.

2. The Prior Arts

A “working draft” of the human sequence produced by the Human Genome Project published in Nature (15 Feb. 2001), simultaneously with a companion publication of the human sequence generated by Celera Genomics Corporation (Science, 16 Feb. 2001). The next important goal is determining the function of the genes. To accelerate the progress of the related research, high-throughput tools for efficient analysis are available. A biochip which contains results of mass samples expressed on the surface of the small solid carrier, is a useful analytic tool. Biochips can be employed in gene expression, drug selection and disease diagnosis in both basic research and clinical application fields.

The DNA chip is the majority type of biochip. FIG. 1 illustrates a detection method of the biochip. A number of known DNA fragments (2) are placed on a surface of a solid carrier to form a DNA chip (1). Generally, DNA probes (2) are arranged in an array called DNA microarray. Unknown DNA fragments (3), target DNA, are labeled with fluorescent dyes. The DNA chip (1) is then hybridized with the target DNA (3). After washing, only DNA fragments, which hybridized with the DNA probes are left on the DNA chip (1). A biochip reader can then read and detect the fluorescence excited from the fluorescent dyes.

FIG. 2 shows a conventional biochip reader. In the biochip reader (4), beams of light emitted from a laser light source (40) which pass through focusing lens (41) and are reflect by a beam splitter (42), and then further pass through the focusing lens (43) to a surface of the biochip (44) that is deposited in the reader (4). The fluorescent dyes on the biochip (44) are excited by the beams and in turn emit the fluorescence (45). The fluorescence (45) so emitted passes through the focusing lens (43), the beam splitter (42), and the focusing lens (46) in sequence. The fluorescence (45) passes through a filter (47). An optic signal is thus applied to a photomultiplier tube (PMT) (48), which converts the optic signal into an amplified electrical signal. The electrical signal is fed to a computer (49) and processed to form an image data. In the conventional biochip reader, to acquire the final result required scanning all samples on the biochip, converting an optic signal into an electrical signal, and processing the electrical signal to form image data for analysis. The conventional biochip is disadvantageous since errors occur in processing the electrical signal into image data. Further, analysis of the image is time consuming.

### SUMMARY OF THE INVENTION

A primary object of the present invention is to provide a biochip scanner device that overcomes the above-mentioned disadvantages and allows for doing a real-time analysis when simultaneously scanning. Scanning all samples on a biochip and forming image data for analysis are no longer necessary. Therefore, easy and efficient operation is realized.

The second object of the invention is to provide a biochip scanner device that reads electrical signal from a photomultiplier tube (PMT) directly without converting the electrical signal into image data first and thus eliminating errors that occur in the conversion processing.

Furthermore, there is no longer a need for setting lens before the PMT. As a result, the structure of the device is simplified and the production cost is reduced.

In order to realize the foregoing objects, a biochip scanner device of the present invention comprises: a light source for emitting a light beam; a light processing unit for focusing the light beam onto the biochip to excite fluorescence from a fluorescent target on the biochip; a filter for filtering off the light beam from the light source; a photomultiplier tube (PMT) for detecting and converting the fluorescence into an electrical signal; and an output device for outputting/displaying the electrical signal detected by the PMT. No conversion of the output signal of the output device into image data is needed. The light processing unit comprises: a beam splitter for redirecting the light beam to pass through focusing lens, which focuses the light beam onto the biochip and excites fluorescence from a fluorescent target on the biochip. Additional focusing lens may be set between the light source and the beam splitter to enhance the focusing effect.

Furthermore, image data may be selectively produced from the signal detected by the PMT. The image data is used for reference in comparison with the detected signal of samples on the biochip. The signal intensity of each sample still comes from the signal detected by the PMT and therefore no errors arise as in the process of converting the electrical signal into image data in the conventional biochip.

A real-time analysis proceeds while samples are being scanned on the biochip. Fluorescence of each sample is collected by the PMT, which converts the fluorescence signal to an electrical signal. Setting lens before the PMT is no longer needed for unnecessary converting the electrical signal into image data.

For more detailed information regarding advantages and features of the present invention, examples of preferred embodiments will be described below with reference to the annexed drawings. It is to be understood that both the foregoing general description and the following detailed description are exemplary and explanatory and are intended to provide further explanation of the invention as claimed.

### BRIEF DESCRIPTION OF THE DRAWINGS

The related drawings in connection with the detailed description of the present invention to be made later are described briefly as follows, in which:

FIG. 1 illustrates DNA chip detection system in the prior art;

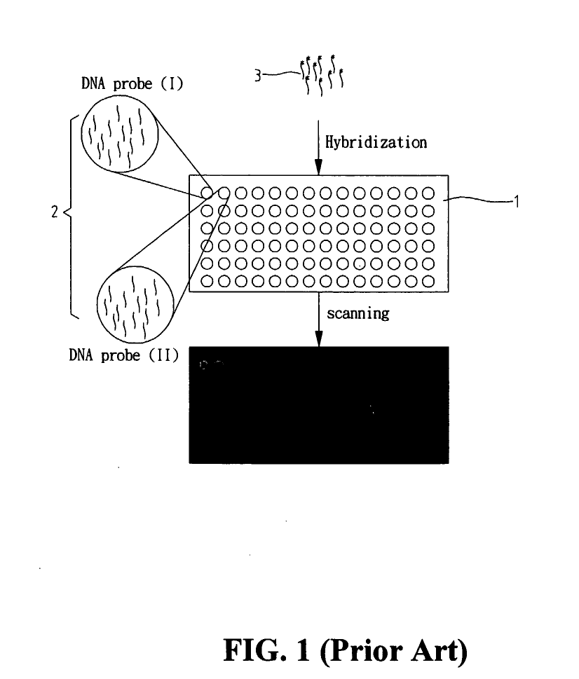

FIG. 2 is a schematic view showing one example of a conventional biochip reader;

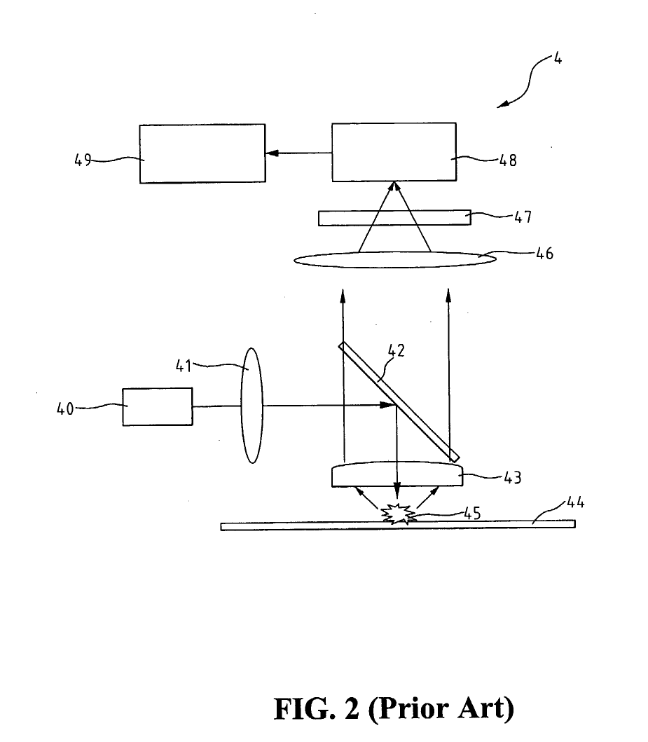

FIG. 3 is a schematic view showing one embodiment of the biochip scanner device of the present invention;

FIG. 4 shows real-time output signal obtained by the biochip scanner device of the present invention;

FIG. 5 shows comparison image data of samples on the biochip obtained by the biochip scanner device of the present invention.

### DETAILED DESCRIPTION OF THE PREFERRED EMBODIMENT

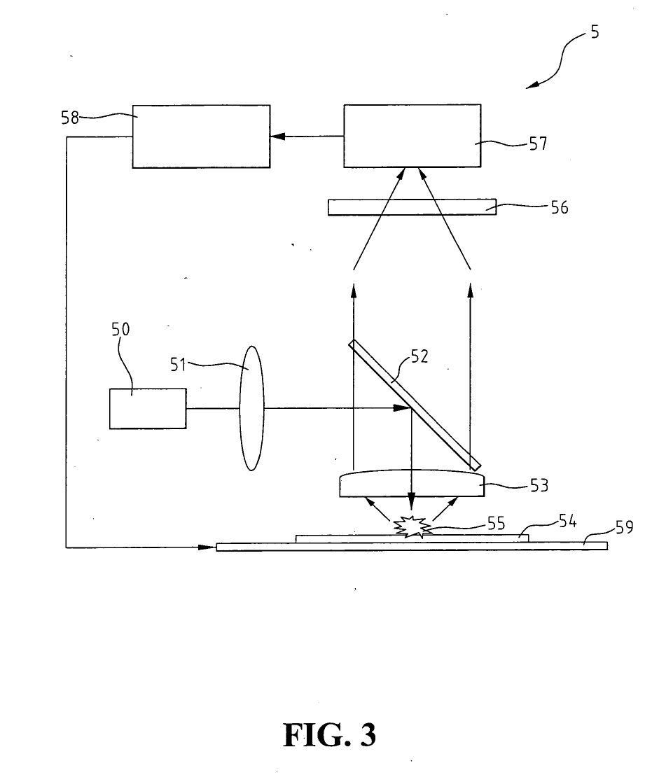

A preferred embodiment of the present invention will now be described in detail below with reference to the accompanying drawings. FIG. 3 shows an embodiment of a biochip scanner device in accordance with the present invention. The biochip scanner device, generally designated with reference (5), comprises a light source (50) for emitting a light beam. A beam splitter (52) redirects the light beam through focusing lens (53), which focus the light beam onto a biochip (54) to cause excitement of fluorescence (55) from a fluorescent target deposited on the biochip (54). A filter (56) filters off the light beam from the light source (50). A photomultiplier tube (PMT) (57) detects the fluorescence and converts the fluorescence into an electrical signal. An output device (58) receives and shows the electrical signal detected by the PMT. Additional focusing lens (51) may be set between the light source (50) and the beam splitter (52) to enhance the focus effect.

A biochip is placed on a platform (59) when analyzed by the biochip scanner device of the present invention. The platform (59) is movable in two different directions, for example X and Y directions, under the control of a computer (58). In scanning, a light beam from a laser source (50) passes through the focusing lens (51) and reaches a surface of the biochip (54). Fluorescence (55) is excited from the fluorescent target on the biochip (54). The fluorescence (55) passes through the beam splitter (52). The light beam from the light source is filtered out by the filter (56), the fluorescence is clearly detected by the PMT (57) and converted into an electrical signal. The electrical signal is transmitted to an output device (58). The signal is output/display directly from the output device (58). For the convenience of result analysis, the output device (58) may be a computer, which may comprise a formula to control the platform (59) more easily.

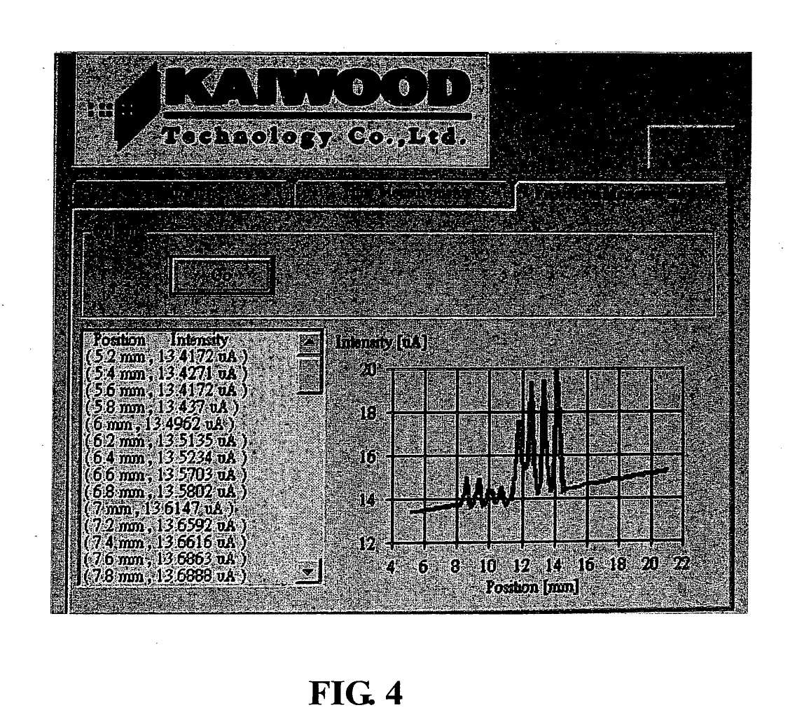

The output signal from the PMT is shown in FIG. 4. A real-time analysis proceeds while samples are being scanned on the biochip. The biochip scanner device of the present invention reads the electrical signal from PMT directly without processing it into image data.

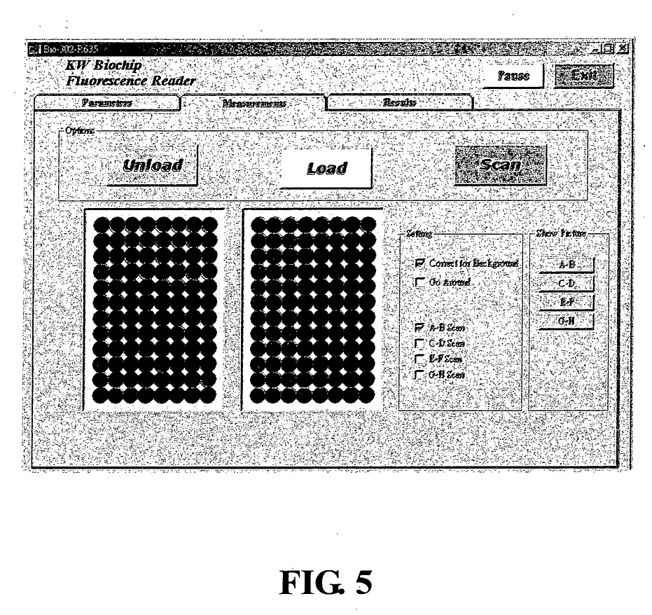

In addition, image data as shown in FIG. 5 may be selectively produced from the signal detected by the PMT. The image data is used for reference in comparison with the detected signal of samples on the biochip. The signal intensity of each sample still comes from the signal detected by the PMT and therefore no errors arise as in the process of converting an electrical signal into image data in the conventional biochip.

1. A biochip scanner device for simultaneous scanning and analysis comprising:
a light source, which emits a light beam;
a light processing unit, which focuses the light beam onto a biochip to excite fluorescence from a fluorescent target on the biochip;
a filter, which filters off the light beam from a light source;
a photomultiplier tube, which detects and converts the fluorescence into an electrical signal; and
an output device, which comprises at least one set of parameters for directly reading the electrical signal detected by the photomultiplier tube without converting the electrical signal into image data.

2. The biochip scanner device according to claim 1, wherein the light processing unit comprises:
a beam splitter for redirecting the light beam through a focusing lens, which focuses the light beam onto the biochip and excites fluorescence from a fluorescent target on the biochip.

3. The biochip scanner device according to claim 2, wherein the light processing unit further comprises another focusing lens between the light source and the beam splitter to enhance the focus effect.

4. The biochip scanner device according to claim 1 further comprising a platform for holding the biochip and moving in two different directions.

5. The biochip scanner device according to claim 4, wherein the output device is a computer comprises at least one set of parameters for controlling the directions of movement of the platform.

6. (canceled)

7. The biochip scanner device according to claim 1, wherein the output device comprises at least one set of parameters for converting the signal detected by the photomultiplier tube into image data.

8. A biochip scanner device for simultaneous scanning and analysis comprising:
a light source, which emits a light beam;
a beam splitter for redirecting the light beam through a focusing lens, which focuses the light beam onto the biochip and excites fluorescence from a fluorescent target on the biochip;
a filter, which filters off the light beam from a light source;
a photomultiplier tube, which detects and converts the fluorescence into an electrical signal; and
an output device, which comprises at least one set of parameters for directly reading the electrical signal detected by the photomultiplier tube without converting the electrical signal into image data.

9. The biochip scanner device according to claim 8 further comprising another focusing lens between the light source and the beam splitter to enhance the focus effect.

10. The biochip scanner device according to claim 8 further comprising a platform for holding the biochip and moving in two different directions.

11. The biochip scanner device according to claim 10, wherein the output device is a computer comprises at least one set of parameters for controlling the directions of movement of the platform.

12. (canceled)

13. The biochip scanner device according to claim 8, wherein the output device comprises at least one set of parameters for converting the signal detected by the photomultiplier tube into image data.

14. A method of simultaneously scanning and analyzing samples on a biochip comprising the steps of:
(a) placing a biochip having fluorescent targets on a platform of a biochip scanner device according to claim 1;
(b) scanning the biochip with a light beam from a laser source, wherein the light beam passes through focusing lens;
(c) exciting the flourenscence with the light beam;
(d) detecting the fluorescence with a photomultiplier tube;
(e) converting the fluorescence into an electrical signal;
(f) transmitting the electrical signal to an output device; and
(g) outputting data on the output device.
